(19) United States
(12) Patent Application Publication
(10) Pub. No.: US 2003/0163707 A1
(43) Pub. Date: Aug. 28, 2003

(54) Information management apparatus and method

(75) Inventor: Nobuyuki Shigeeda, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/373,041

(22) Filed: Feb. 26, 2003

(30) Foreign Application Priority Data
Feb. 26, 2002 (JP) 2002-050290

(51) Int. Cl. G06F 12/14

(52) U.S. Cl. 713/182

(57) ABSTRACT

An information management apparatus has a data management unit for controlling accesses to data which are stored in respective storage areas using authentication information, a storage area designation unit for designating one of the storage areas, an authentication information acquisition unit for recognizing the designated storage area, and acquiring encrypted authentication information required to access control to the designated storage area from a directory server, and a decryption unit for decrypting the acquired encrypted authentication information. The data management unit authenticates access to data in the designated storage area on the basis of the decrypted authentication information. With this apparatus, user's input operation of authentication information can be simplified, and operational convenience can be improved.

### FIELD OF THE INVENTION

The present invention relates to a user authentication function of an application, operation system, and apparatus having a security function that allows to set user passwords for respective cabinets and, more particularly, to an information management apparatus and method, which can suitably improve user's convenience by simplifying the input operation of user authentication information while assuring high security of each cabinet.

### BACKGROUND OF THE INVENTION

Conventionally, a digital copying machine which has a function of scanning document data and holding data in its internal storage area, and a file management module which is used to hold and manage document data and file information that can be processed by a computer have a data storage area for efficiently holding and managing data (this data storage area will be referred to as a “cabinet” hereinafter).

The cabinet is also called a box, folder, or the like, and can be considered as a logical data storage area having an arbitrary hierarchical structure. In this cabinet, user authentication information (to be referred to as “authentication information” hereinafter) used to specify a user so as to guarantee security of data held and managed in the cabinet can be set for each cabinet. Hence, every time the user wants to access information stored in the cabinet, he or she can access managed data after he or she inputs authentication information set for that cabinet, and is authenticated by the system.

However, in such apparatus or system, the user must input authentication information every time he or she accesses data stored in the cabinet. When respective cabinets store a plurality of pieces of different authentication information, authentication processes are required for respective cabinets, thus requiring much labor and time.

In order to solve such problem, a method for taking an operational solution that uses authentication information common to all cabinets, and a method that uses a technique called “single sign-on” have been proposed. Using this technique called “single sign-on”, once the user inputs authentication information and is authenticated, he or she can access a cabinet in which that authentication information is set without inputting authentication information. In this manner, the need for inputting authentication information for each cabinet can be obviated, and a plurality of pieces of authentication information need not be stored, thus improving user's convenience.

However, with the conventional operational solution which sets common authentication information to all cabinets, all users who can set authentication information of cabinets must be familiar with operation rules, and convenience may be impaired again in this respect. In addition, since common authentication information is set for all cabinets, it is difficult to guarantee security of such common authentication information to pose another serious problem; the cabinet security deteriorates substantially.

On the other hand, in order to use the single sign-on technique, an existing digital copying machine or file management system having a cabinet function, which has already been introduced to the user, cannot be directly used, and a new model or new version, which is developed to conform to a predetermined single sign-on system, must be used instead. Introduction of such new model or version imposes another load on the user in terms of cost and management.

For example, it is generally difficult to transfer the setups of authentication information in the existing apparatus or file management system to a new system. Hence, the user must re-set authentication information and must transfer data held and managed in the cabinets, resulting in troublesome operations.

Since the design of the apparatus or file management system depends on the specifications of a specific single sign-on system, it is also difficult to provide flexible product specifications to the user.

### SUMMARY OF THE INVENTION

The present invention has been made to solve such conventional problems which remain unsolved to date, and has as its object to provide an information management apparatus and method which can suitably improve operational convenience by simplifying user's input operation of authentication information while guaranteeing data security.

An information management apparatus and method according to the present invention, which can achieve the aforementioned object, are mainly characterized by the following arrangements.

That is, the present invention provides an information management apparatus comprising: data management means for controlling accesses to data which are stored in respective storage areas using authentication information; storage area designation means for designating one of the storage areas; authentication information acquisition means for recognizing the storage area designated by that storage area designation means, and acquiring encrypted authentication information required to access control to the designated storage area from authentication information management means; and decryption means for decrypting the acquired encrypted authentication information, wherein that data management means authenticates access to data in the designated storage area on the basis of the decrypted authentication information.

Furthermore, the present invention provides an information management method comprising: the storage area designation step of designating one of storage areas which undergo storage management for each storage area using individual authentication information; the acquisition step of acquiring profile information corresponding to the designated storage area; the specifying step of specifying authentication information management means that holds encrypted authentication information corresponding to the designated storage area on the basis of the acquired profile information; the initial authentication checking step of binding to the specified authentication information management means; and the storage area use step of decrypting encrypted authentication information managed in the specified authentication information management means, and authenticating access to data stored in the storage area designated in the storage area designation step on the basis of the decrypted authentication information.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining the overall system arrangement according to an embodiment of the present invention;

FIG. 2 is a block diagram for explaining the detailed arrangement of a user computer according to the embodiment of the present invention;

FIG. 3 is a diagram for explaining the configuration of cabinets in a file management module according to the embodiment of the present invention;

FIG. 4 is a view for explaining the definition of a schema in a directory server according to the embodiment of the present invention;

FIG. 5 is a flow chart for explaining the flow of the overall process of information management according to the embodiment of the present invention;

FIG. 6 is a flow chart for explaining the flow of an initial authentication process in information management according to the embodiment of the present invention;

FIG. 7 is a flow chart for explaining the flow of an authentication process required to use a cabinet in information management according to the embodiment of the present invention; and

FIG. 8 is a flow chart for explaining the flow of a user authentication information search process in information management according to the embodiment of the present invention.

### DETAILED DESCRIPTION OF THE PREFERRED EMBODIMENTS

Preferred embodiments of the present invention will now be described in detail in accordance with the accompanying drawings.

<Outline of System>

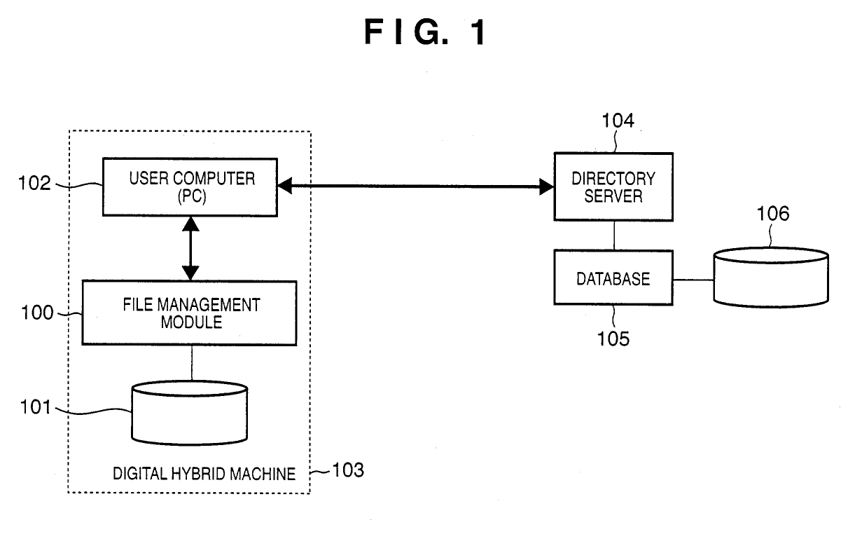

FIG. 1 is a schematic block diagram of a system which registers user authentication information for respective cabinets, and systematically manages users' accesses. Referring to FIG. 1, a file management module 100 can logically generate, save, and manage a plurality of cabinets used to save document data and the like.

Cabinets are generated in a predetermined storage area of a storage device 101 connected to the file management module 100, and various generated data are saved and managed in a predetermined cabinet generated in the storage device 101. The file management module 100 and storage device 101 are physically connected to each other via a predetermined signal line that allows exchange of data.

The function of the file management module 100 is implemented as software on a host user computer (to be referred to as a “PC” hereinafter).

A PC 102 provides a user interface required for the user of the file management module 100, and its interface function is implemented by software, which runs on a predetermined storage area of the PC 102.

Note that the PC 102 comprises a CPU, ROM, RAM (primary storage device), I/O device, hard disk (secondary storage device), input/output devices (CRT, keyboard, mouse, and the like), and system bus which interconnects these components (none of them are shown). The PC 102 can execute a predetermined process by loading software stored in the ROM and hard disk onto a predetermined memory space, and controlling the CPU, I/O device, and the like on the basis of the software.

A digital hybrid machine 103 in FIG. 1 at least includes functional arrangements implemented by the file management module 100, storage device 101, and PC 102, which are bounded by the dotted line.

The digital hybrid machine 103 includes a multi-purpose network apparatus called an MFP (MULTI FUNCTION PERIPHERAL). The apparatus according to the present invention serves as an information management apparatus upon accessing predetermined data in access control of data among respective functions, i.e., a scanner function, print function, facsimile function, and the like of the MFP, in data control from a host computer connected to a network, and upon editing data.

Data management is implemented by applying LDAP (Lightweight Directory Access Protocol) as a control protocol. LDAP is a standard directory access protocol which was developed by WG of IETF to serve as a lightweight frontend with respect to X.500 directory access protocols of the OSI, and its specifications are specified in RFC1777, RFC2251, and the like.

A database 105 connected to a directory server 104 serves as a backend of the directory server 104, and handles various directory objects as a database.

Entities of the directory objects are held in a storage device 106 connected to the database 105. The directory server 104 and PC 102 are connected to the network via network interface cards (not shown), and can make information communications using a standard network protocol (e.g., TCP/IP or the like). The aforementioned LDAP runs on the standard network communication protocol as a protocol of the application layer.

Note that the directory server 104, database 105, and storage device 106 described in this embodiment may be configured by using Active Directory Server and Novell Directory Service, which are commercially available as products that provide a directory server function, Open LDAP which are distributed as an open source, and the like.

<Description of Cabinet>

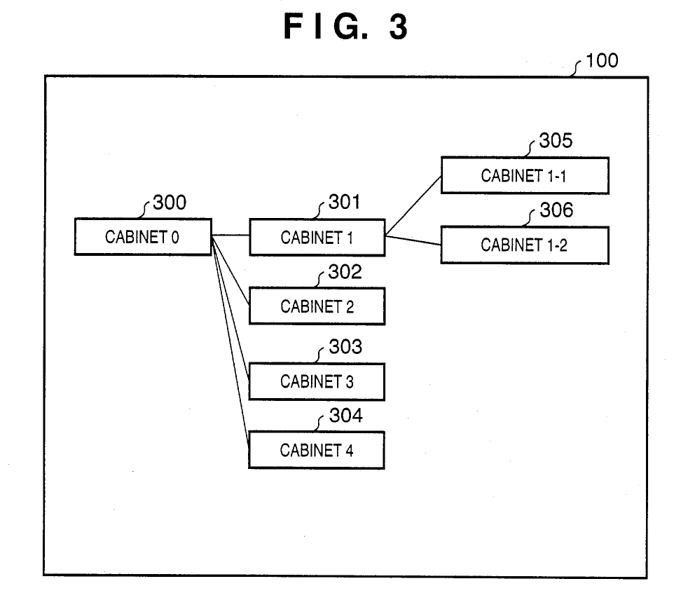

The contents of a cabinet provided by the file management module 100 in FIG. 1 will be briefly explained below using FIG. 3. As has been explained in the prior art, a cabinet is also called a box, folder, or the like, and can be considered as a logical data storage area having an arbitrary directory structure. The cabinet has a logical hierarchical structure used to efficiently hold and manage documents and various user data. Furthermore, authentication information can be set for each cabinet, so as to guarantee security of data held and managed in the cabinet. In order to specify one cabinet in a given system, a name assigned to that cabinet is normally designated. In some systems, however, an ID value that specifies a given cabinet is held by software, and is used to specify the cabinet. It is effective to flexibly change the cabinet name later.

Cabinet 0 (300) in FIG. 3 is a root cabinet. A plurality of cabinets 1 (301), 2 (302), 3 (303), 4 (304), and the like can be formed in this cabinet 0 to form a hierarchical structure. For example, the user can define specific meanings of a plurality of cabinets in consideration of convenience of the respective cabinets, and can save document files, image data, and the like. Furthermore, a plurality of layers of cabinets can be formed. Cabinets 1-1 (305) and 1-2 (306) in FIG. 3 indicate the configuration of cabinets formed in cabinet 1 (301). The user of the file management module 100 can arbitrarily determine the logical structure of cabinets.

Assume that authentication information associated with each cabinet is held by each cabinet as logical information in the file management module 100. That is, authentication information required to access cabinet 0 (300) is held in association with each user as information attached to cabinet 0 (300).

As information associated with each user, an operation authority level or the like of that user may be attached in addition to the authentication information which grants permission to access to each cabinet. In this case, access to a cabinet of a given user may be divided into many authority levels such as “read only”, “write”, “run”, and the like in accordance with the types of operations, so as to control access to the cabinet. Authentication information attached to a cabinet can be set for each cabinet, and when the operation authority level is superposed on that information, data can be effectively held and managed with especially high security.

Note that the digital hybrid machine 103 has a similar cabinet function although it has some differences upon design such as limitations on the hierarchical structure, the structure of an authentication control list, and the like.

<Arrangement of User Computer>

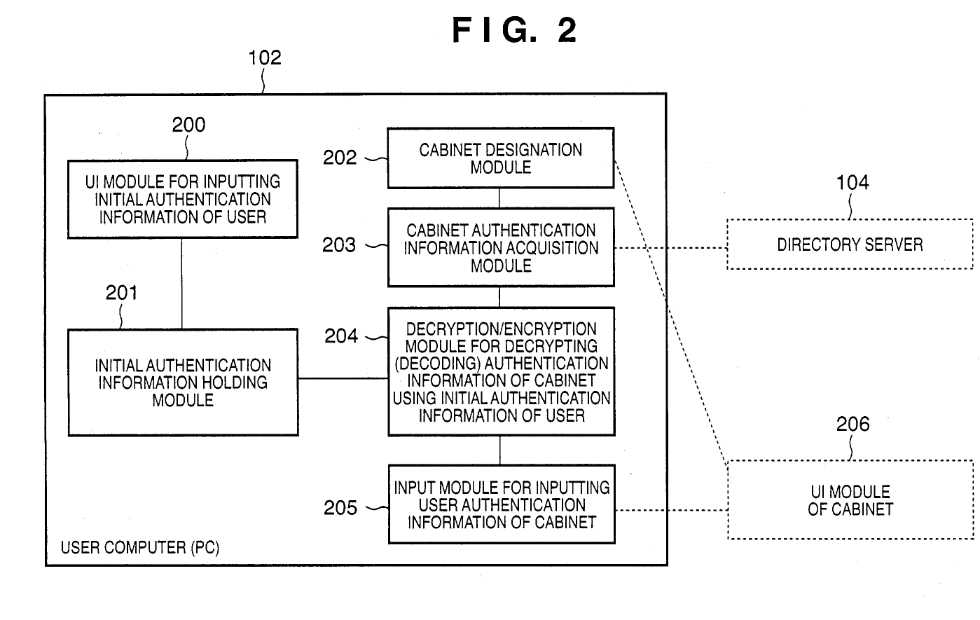

FIG. 2 is a block diagram showing the characteristic arrangement of the PC 102. The connection relationship among the directory server and a user interface (UI) module 206 of a cabinet, which are indicated by the broken line in FIG. 2, and the user computer 102 is indicated by the broken lines, and the connection relationship among internal modules of the PC 102 is indicated by the solid lines.

A user interface (UI) module 200 provides a process module at which the user inputs initial authentication information required to use the system. This process corresponds to an action called login (or logon) to the system, and is required for the user to use this system for the first time. As a login function, in this embodiment, a dialog box used to input initial authentication information is displayed on a PC display (not shown) to prompt the user to input initial authentication information, and it is collated to determine if the initial authentication information input by the user is authentic.

Assume that the initial authentication information of the user, which has undergone the input process in the UI module 200 by the PC 102, is securely held in an internal storage area of the PC 102 during a predetermined period in which that user has authority. The “predetermined period in which the user has authority” is a period until that user is finished with the system, and executes logout procedures. The initial authentication information is securely held by an initial authentication information holding module 201 in FIG. 2, and such holding process is implemented by holding that information in a temporary storage area of the PC 102 in a format that allows access from only the PC 102.

Furthermore, the PC 102 provides a user interface required to operate the file management module 100 to the user of the file management module 100. That is, the user makes operation for designating a predetermined cabinet via that user interface so as to access that cabinet generated in the file management module 100. A cabinet designation module 202 recognizes a cabinet designated by the system user, and acquires the name of that cabinet in cooperation with the aforementioned user interface. The “name” of a cabinet is information required in a subsequent process so as to acquire authentication information associated with that cabinet.

In this embodiment, the name of a cabinet is acquired to specify that cabinet. In place of the name, a unique ID as identification information associated with a cabinet may be used. Either one of these methods to be adopted is determined depending on the configuration method of cabinets in the file management module 100, the management method of a plurality of cabinets, and the like, and a method with high design efficiency can be selected.

A module 203 that acquires authentication information of a cabinet acquires user authentication information of that cabinet from the directory server 104 by designating the initial authentication information input by the user who has logged on the system, and the cabinet name or ID (identifier) unique to that cabinet acquired by the cabinet designation module 202. As described above, since the directory server 104 supports LDAP, the authentication information acquisition module 203 that acquires authentication information of a cabinet has a function as an LDAP client, and acquires predetermined user authentication information by LDAP.

The user authentication information acquired from the directory server 104 is encrypted using the initial authentication information for each user using a predetermined encryption algorithm. The encrypted user authentication information is decrypted by a decryption/encryption module 204 that decrypts (decodes) the authentication information of the cabinet using the initial authentication information input by the user. The decryption/encryption module 204 is implemented by a software program which includes a predetermined encryption process engine, and can execute encryption and decryption processes of the user authentication information. Of course, this process may be implemented by hardware to assure effective processing performance.

The user authentication information which is set for each cabinet is encrypted in advance by the decryption/encryption module 204 using the initial authentication information of the user, and is held in the directory server 104.

On the other hand, when the user wants to access data stored in the cabinet, the cabinet authentication information acquisition module 203 acquires the encrypted user authentication information from the directory server 104 on the basis of the cabinet name or ID unique to the cabinet, and the initial authentication information input by the user, and the decryption/encryption module 204 decrypts the acquired user authentication information.

The initial authentication information of the user, which serves as a secret key in the encryption and decryption processes is held by the aforementioned initial authentication information holding module 201, and the decryption/encryption module 204 acquires the initial authentication information of the user from this initial authentication information holding module 201.

Note that the process engine in the aforementioned decryption/encryption module can support various existing encryption/decryption algorithms, and the system may use any one of these algorithms.

Furthermore, since the encryption and decryption processes of the user authentication information are executed as closed process within the PC 102, the initial authentication information used to encrypt/decrypt the user authentication information never flows on the network to be open to the public. Hence, a problem of illicit eavesdropping on the network in an attempt to steal initial authentication information of the user can be avoided.

The decrypted (decoded) user authentication information is input to a user interface 206 by an input module 205. Conventionally, a user interface comprises a dialog used to input authentication information, and the user manually inputs user authentication information to the dialog for each cabinet. However, in the system according to this embodiment, the unit 205 which inputs the user authentication information of a cabinet automatically hooks the dialog to act for input of the user authentication information. For this reason, the input operation of the user authentication information of the cabinet is automated.

As has been described above, a series of sequences such as search, acquisition, and decryption processes of user authentication information of a cabinet, and an input process of the user authentication information to the dialog are automated, and the user is free from any input operation of the user authentication information of a cabinet.

Since the input process of the user authentication information is automatically done as a backend process of this system, the user need not store unique user authentication information set for each cabinet. That is, upon using this system, after the user inputs initial authentication information and is authenticated, he or she need only access a cabinet that he or she wants to use. After that, the system automatically inputs the user authentication information of the designated cabinet to this cabinet to permit the user to access the cabinet.

<Data Matching Between Directory Server 104 and Database 105>

Given rules (to be referred to as schema hereinafter) that pertain to information management of user authentication information, which is held in the database 105 via the directory server 104, will be explained below.

The user authentication information must be input by the user to access a cabinet in the file management module 100. This user authentication information is not directly held in the directory server 104, but is encrypted according to a predetermined encryption algorithm in the decryption/encryption module 204 and is then sent to, held in, and managed by the directory server 104.

This is to prevent another user who also has authority to systematically manage the directory server 104 from illicitly referring to user authentication information held for each user in the directory server 104. That is, since the administrator of the directory server 104 is not always that (or the user) of the file management module 100, the schema is designed to prevent user authentication information required to access a cabinet of the file management module 100 from being stolen.

For the sake of simplicity, a name that specifies cabinet X is expressed by “CabinetX”, and user authentication information of user Y corresponding to that cabinet X is expressed by “passYX”.

Furthermore, arbitrary information “M” is assumed, and encryption of this information using a given encryption key “k” is expressed by “Ek(M)”.

If these expressions are used as rules, for example, user authentication information of user 1 set in cabinet 1 (301) is expressed by “pass11”, and encryption of this information using encryption key k1 of user 1 is expressed by Ek1(pass11).

In addition, association of the user authentication information, which is associated with cabinet 1 (301) with name Cabinet1 that specifies this cabinet 1 (301) is expressed by:

Ek1(pass11):Cabinet1

In this embodiment, “cabinetPerson” which means a class of a user who uses a cabinet is defined as the schema in the directory server 104. Also, as for the user class, “encryptedPass” as a value which associates given encrypted user authentication information with a cabinet is defined as an attribute. The following example describes definitions of the object class and attribute according to the RFC2252 regulations:

objectclass (1.1.2.2.1 NAME ‘cabinetPerson’

DESC ‘cabinet user’

SUP person STRUCTURAL

MUST (‘encryptedPass’))

attributetype (1.1.2.1.1 NAME ‘encryptedPass’

DESC ‘encrypted password for cabinet’

SYNTAX 1.3.6.1.4.1.1466.115.121.1.40)

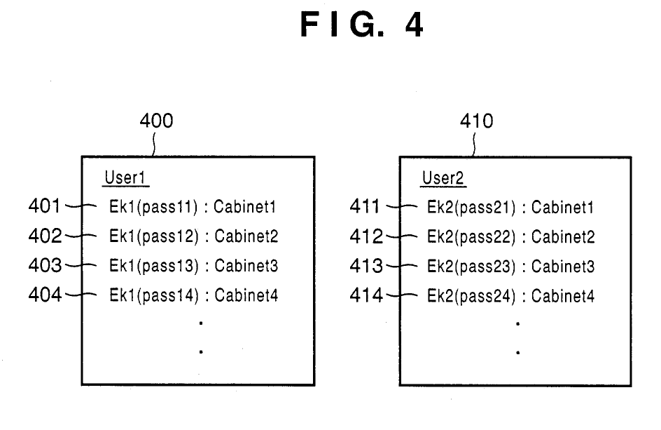

Using the schema defined in this way, the system holds user authentication information for each user in the directory server 104 in association with each cabinet. FIG. 4 shows this state. Referring to FIG. 4, a data group (400) of User1 and a data group (410) of User2 are objects defined by the cabinetPerson class. Each object possesses encrypted user authentication information associated with each cabinet as the encryptedPass attribute.

That is, User1 (400) holds encrypted user authentication information 401 corresponding to cabinet 1 (301), encrypted user authentication information 402 corresponding to cabinet 2 (302), and user authentication information 403 and 404 corresponding to cabinets 3 (303) and 4 (304). The same applies to User2 (410).

Ek1(pass11):Cabinet1 (401) as one of encryptedPass attributes possessed by User1 (400) means that given user 1 sets pass11 as user authentication information for cabinet 1, this user authentication information is encrypted by encryption key k1 of user 1, and is held in the directory server 104 in association with cabinet 1, as described above.

On the other hand, in case of encryptedPass attributes possessed by User2 (410), Ek2(pass21):Cabinet1 (411) means that user authentication information pass1 set for cabinet 1 is encrypted using encryption key k2 of user 2. Therefore, since these attributes use different encryption information based on user authentication information even for an identical cabinet, user 1 cannot acquire and decode user authentication information for a cabinet of user 2, thus improving information security.

Objects defined by the cabinetPerson class can be dynamically changed in accordance with the registration state of users. Also, encrypted user authentication information associated with each cabinet, i.e., the encryptedPass attribute changes in accordance with the registration state of a cabinet that the user who possesses this attribute uses.

Note that user registration and setups of access to cabinets are made at the file management module 100 first, and the file management module 100 soaks up user registration and setup states and reflects them in the directory server 104. A function of referring to registered users and access setups of cabinets and reflecting them in the directory server 104 (to be referred to as synchronize function” hereinafter) is equipped and implemented by the cabinet authentication information acquisition module 203 in FIG. 2. The synchronize function is periodically and automatically processed by a daemon program which is registered as a service of the PC 102. On the other hand, the administrator of this system can manually execute this process when it is necessary. The operation mode of this synchronize function can be selectively switched by the administrator.

The schema in the directory server 104 may be defined in a format other than that exemplified above in this embodiment. For example, cabinets themselves can be defined as classes in place of classification based on users who use cabinets. In this case, the cabinet class possesses a value which associates the encrypted user authentication information with the cabinet user as an attribute. The following example describes the definitions of the object class and attribute in this case according to directives specified in RFC2252:

objectclass (1.1.2.2.1 NAME ‘cabinetName’

DESC ‘cabinet name’

SUP top STRUCTURAL

MUST (‘encryptedUserPass’))

attributetype (1.1.2.1.1 NAME ‘encryptedUserPass’

DESC ‘encrypted password for user’

SYNTAX 1.3.6.1.4.1.1466.115.121.1.40)

<Description of Operation Sequence>

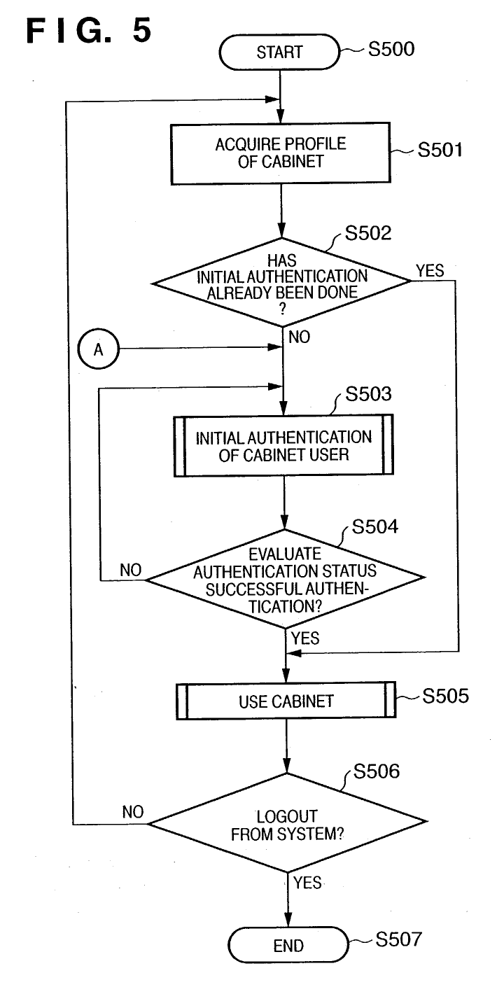

The processing operation sequence for systematically managing user authentication information which can be registered for each cabinet in the system or apparatus according to this embodiment will be described below with reference to the flow charts shown in FIGS. 5 to 8.

FIG. 5 is a flow chart for explaining the overall operation sequence of the system according to this embodiment.

When the user launches the system, this flow starts (S500).

If the user is about to access an arbitrary cabinet managed in the file management module 100, the system acquires a profile of the cabinet that the user accessed in step S501, i.e., acquires authentication server information which manages authentication data used to authenticate access to that cabinet.

Note that the “profile” consists of information that pertains to an authentication server used to authenticate user's access to an arbitrary cabinet, e.g., location information (IP address or the like) on the network, a data communication protocol (LDAP or the like), and the like. This profile information is held by the file management module 100, and the PC 102 specifies an authentication server to be accessed and an authentication method to be used with reference to the profile. The user acquires the profile by accessing the cabinet, and can also acquire authentication status in the system together.

In step S502, the authentication status is checked. That is, it is checked if the user has already input initial authentication information and has logged on the system. If it is determined in step S502 that initial authentication is not complete yet (S502—NO), the flow advances to an initial authentication process of the cabinet user in step S503. If initial authentication is complete and the user has logged on the system (S502—YES), the initial authentication process of the user is skipped, and the flow jumps to a cabinet use process (S505).

In step S503, initial authentication of the user of the file management module 100 is done. Details of this initial authentication will be described later. The initial authentication result is checked in step S504 that evaluates authentication status. If it is determined in step S504 that the user is an authentic, registered user (S504—YES), the flow advances to the next cabinet use process. On the other hand, if user's authentication status indicates unsuccessful authentication (e.g., when the user inputs wrong initial authentication information) (S504—NO), the flow returns to step S503 to wait for user's input of correct initial authentication information.

If the user is authenticated (S504—YES), the initial authentication information of that user is held and managed by the initial authentication information holding module 201 in the PC 102.

In the cabinet use process in step S505, a data process required for the user to access the designated cabinet is executed. Details of this process will be explained later.

If the user is finished with the cabinet, it is checked if the user logs out the system. If the user selects to log out (S506—YES), the system terminates normally, and the initial authentication information and authentication status of the user held in the PC 102 are completely discarded. On the other hand, if the user is only temporarily finished with the cabinet, and wants to use the cabinet again, i.e., he or she does not select to log out (S506—NO), the flow returns to step S501 that acquires the profile of the cabinet.

<Initial Authentication Sequence>

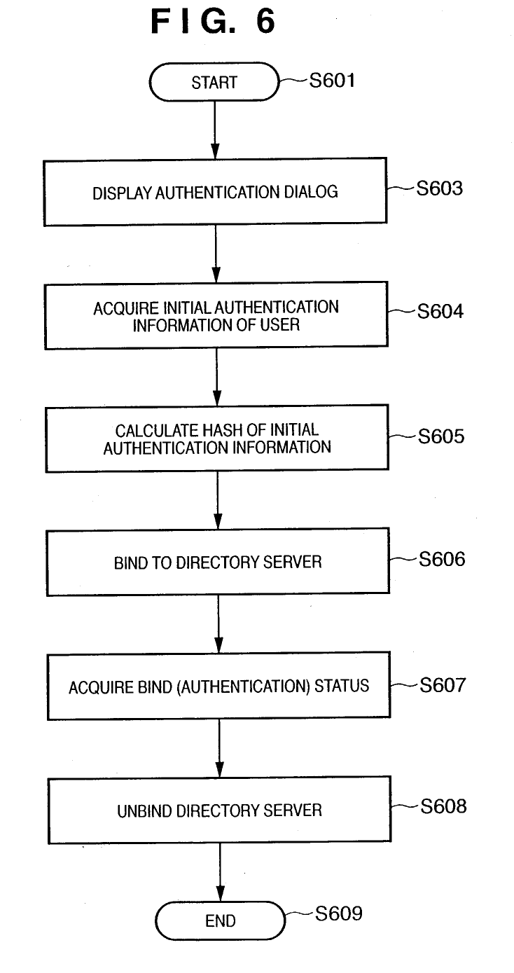

FIG. 6 is a flow chart for explaining the detailed sequence of the initial authentication process of the cabinet user in step S503 in FIG. 5.

If the user has not undergone initial authentication upon accessing a cabinet, this process must be executed. When the user accesses a cabinet, the sequence shown in FIG. 6 starts (S601). Upon execution of this process, information of the cabinet that the user wants to access, and data that pertains to an authentication server used to authenticate that cabinet have already been acquired by the process in step S501 in FIG. 5.

An authentication method is specified based on the information that pertains to the authentication server, and a display process of an authentication dialog is executed (S603). The user inputs initial authentication information that the user himself or herself manages to the authentication dialog displayed in this process.

In step S604, the initial authentication information of the user input to the dialog is fetched inside the system by software.

In step S605, a hash of the initial authentication information is calculated. A predetermined hash algorithm is applied to the fetched initial authentication information of the user to calculate a hash. The “hash algorithm” is an arithmetic algorithm which is characterized in that a fixed-length data output is obtained to have data with an arbitrary length as an input, and input data cannot be restored from output data. A function based on that algorithm is called “hash”, and also a unidirectional function in some cases.

The initial authentication information of the user is data which is to undergo an authentication process that grants permission of access to a cabinet managed in the system, and has very high secrecy. Therefore, since such information cannot be directly output onto the network, the hash of the initial authentication information is calculated in step S605, and an authentication request is issued to the authentication using this hash.

If the directory server 104 is considered as one of authentication servers, an authentication request to this directory server is processed in a process (S606) that binds to this server. The aforementioned hash is sent to the directory server, and authentication is done by an LDAP bind process.

If the user's hash is normally authenticated in the bind process in step S606, connection to the directory server 104 is established, and data communication control by LDAP is allowed. The bind, i.e., authentication result is returned to the PC 102 as an LDAP bind response, and undergoes a bind (authentication) status acquisition process (S607). The bind (authentication) status returned as the response is temporarily held here.

The process of this embodiment corresponds to a so-called simple bind operation that calculates the hash of initial authentication information, and executes a bind operation based on this hash. However, an authentication bind (also called SASL bind) process using an existing encryption communication protocol (e.g., SSL, Kerberos, or the like) may be executed so as to assure strong security. In such case, the process (S605) for calculating the hash of the initial authentication information of the user need not be executed. A bind operation to be executed is controlled based on the initial setups of the system.

After the bind operation is executed (S606) and its authentication status is acquired (S607), the flow advances to step S608 to unbind connection to the directory server. In this process, connection is established only for the purpose of authenticating the user, but not for a directory search or the like.

The bind status that authenticates connection is temporarily held, and the initial authentication flow of the user ends (S609). The temporarily held bind status is devoted to the process (S504: FIG. 5) for evaluating the authentication status in FIG. 5 to see if the user can log on the system.

After the user is authenticated based on the initial authentication information (S504—YES), he or she can use the cabinet of the file management module 100 (S505).

<Use of Cabinet>

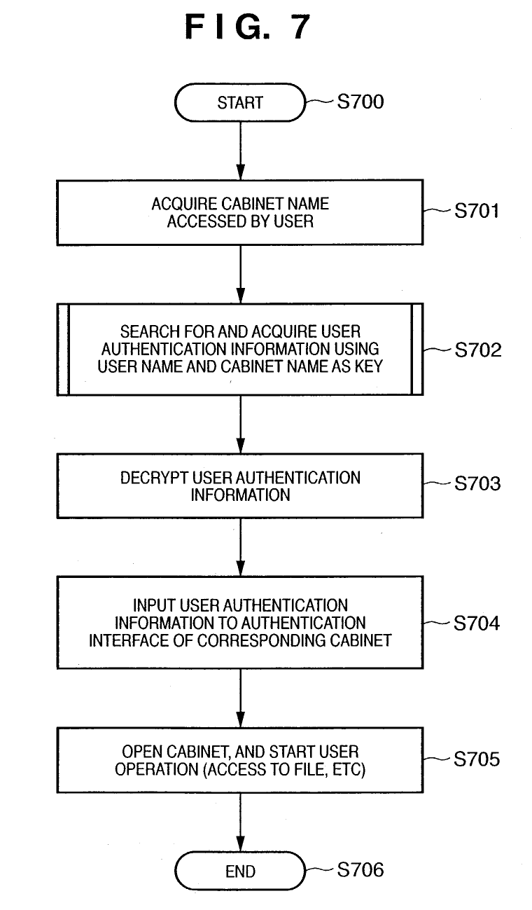

FIG. 7 is a flow chart for explaining a process executed when the user uses a cabinet. As has been explained above using the flow charts of FIGS. 5 and 6, if initial authentication of the user is normally done, the use flow for the cabinet designated by the user starts (S700).

When the user designates a cabinet that he or she wants to access, the cabinet designation module 202 recognizes that cabinet, and acquires the cabinet name or ID unique to that cabinet to which the user accessed (S701).

Furthermore, in step S702 the authentication information acquisition module 203 acquires the user name of the user who has logged on the system, on the basis of the initial authentication information, and makes the predetermined directory server 104 search for user authentication information using, as a key, a combination of the acquired user name and the cabinet name or ID unique to that cabinet, which has been acquired previously, thus acquiring a search result. Since the directory server 104 supports LDAP, the authentication information acquisition module 203 that acquires authentication information of a cabinet has a function as an LDAP client, and can acquire predetermined user authentication information by LDAP. The process in step S702 will be described in detail later.

Since the user authentication information acquired in the above step is encrypted, as described above, the encrypted user authentication information is decrypted in step S703. This decryption process uses the initial authentication information of the user as an encryption key on the basis of a predetermined decryption/encryption algorithm.

In step S704, the decrypted user authentication information is input to an authentication interface of the corresponding cabinet. Note that the authentication interface of the cabinet is an authentication dialog box, and the decrypted user authentication information is automatically input to this dialog box.

Note that the aforementioned “authentication interface” can use a software interface, which is exclusively designed to cope with the system according to the present invention. That is, an API (Application Program Interface) which receives authentication information of a cabinet as an input parameter may be designed in the user computer of the file management module 100.

Then, the input module 205 which inputs the user authentication information of the cabinet calls that API to pass the user authentication information of the cabinet to the file management module 100 as a software process. In this case, the authentication dialog of the cabinet can be omitted.

If the input of the user authentication information to the cabinet is complete, and authentication has succeeded on the file management module 100 side, the user can access the designated cabinet. Then, the user can open that cabinet to start his or her operation (S705).

If the user is finished with the cabinet in step S706, it is checked if the user wants to log out the system or to successively use the cabinet (S506: FIG. 5).

The user may use the identical cabinet again or may use another cabinet. In either case, the flow returns to step S501 of acquiring the profile of a cabinet in FIG. 5. For example, if the user accesses a cabinet which holds a profile that uses a different authentication server, that user has already undergone initial authentication in the previous cabinet but has not undergone initial authentication yet in the newly accessed cabinet. Hence, the initial authentication process of the cabinet user in step S503 is executed again.

Since the initial authentication information and authentication status of the user are held in a predetermined storage area of the PC 102 unless the user logs out the system, the user can use the authenticated cabinet again (S505). On the other hand, if the user is finished with the system and selects logout (S506—YES), use of the system according to the present invention comes to an end, and a required end process is executed (S507).

<Search for User Authentication Information>

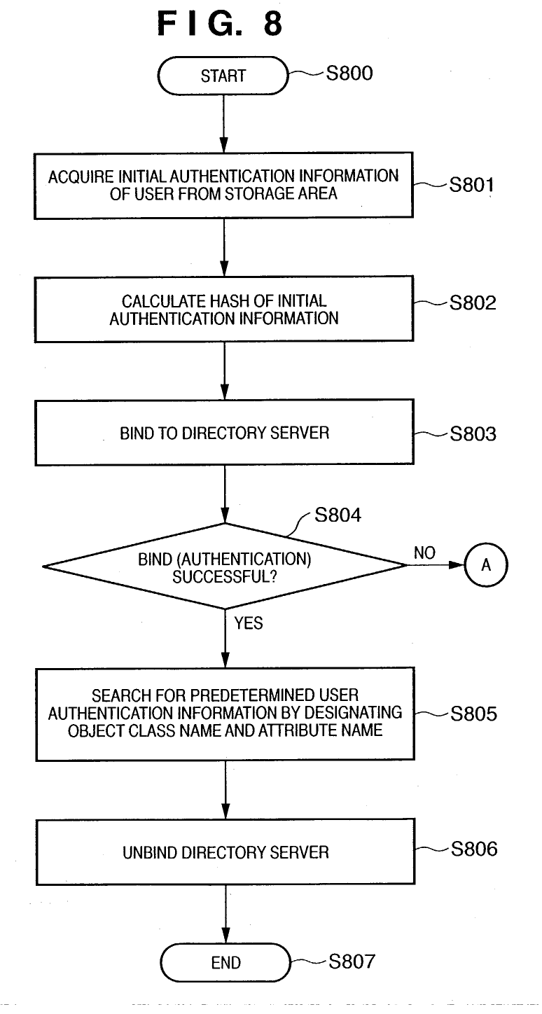

Details of the process for searching for user authentication information using the user name and cabinet name as key information to acquire it on the PC 102 side in step S702 in FIG. 7 will be described below using the flow chart in FIG. 8.

If the cabinet name or ID unique to the cabinet that the user wants to use is acquired in the cabinet use process in step S505 in FIG. 5 (S701), a user authentication information search process starts (S800). This user authentication information search process (S800) is implemented by executing an LDAP search operation. For this purpose, an LDAP bind (authentication) operation must be executed using the initial authentication information of the user. In step S805, the initial authentication information of the user is acquired from the storage area. This initial authentication information serves as data as a basis of the bind operation.

The hash of the initial authentication information of the user acquired in step S801 is calculated using a predetermined hash algorithm (S802). This hash corresponds to an authentication value in the bind operation that acquires bind (authentication) status in the above description. The authentication information acquisition module 203 that acquires authentication information of a cabinet in FIG. 2 binds to the directory server using that hash (S803).

In step S804, the control waits for a response of the bind operation to see if bind (authentication) has succeeded. If the bind operation has failed (S804—NO), since the initial authentication information of the user must be acquired again, the flow advances to the initial authentication process of the cabinet user in step S503 in FIG. 5. On the other hand, if authentication has succeeded (S804—YES), the flow advances to step S805 to actually acquire the user authentication information of the cabinet.

Upon acquiring the user authentication information, predetermined user authentication information is acquired by designating the object class name and attribute name. In this embodiment, the values “cabinetPerson” and “encryptedPass” are respectively designated as the object name and attribute name, as has been explained using FIG. 4. As a result of the search operation, the directory server 104 searches for and acquires encrypted user authentication information associated with the predetermined cabinet.

The acquired user authentication information is sent to the authentication information acquisition module 203 by the LDAP protocol as encrypted data.

After that, the LDAP process advances to a directory server unbind process (S806). In this way, a series of LDAP operation processes associated with acquisition of the user authentication information end (S807).

The encrypted user authentication information is decrypted in the processes in steps S703 to S705 described above, and the decrypted user authentication information is input to the authentication interface, thus allowing user's access to the designated cabinet.

<Another Embodiment>

Note that the present invention may be applied to either a system constituted by a plurality of devices (e.g., a host computer, interface device, reader, printer, and the like), or an apparatus consisting of a single equipment (e.g., a copying machine, facsimile apparatus, or the like).

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

As described above, according to the information management apparatus and method of the present invention, when accesses to data stored in respective storage areas are controlled using a plurality of pieces of authentication information corresponding to these storage areas, the user can access data stored in the plurality of storage areas via only one authentication process without repeating authentication a plurality of number of times. Hence, the user's convenience can be improved while maintaining high security of data stored in the storage areas.

More specifically, as described above, according to the information management apparatus and method of the present invention, the user can freely access a plurality of cabinets via only one authentication process in authentication of individual cabinets of an existing digital copying machine or file management module. Hence, the user's convenience can be improved while maintaining high security of the cabinets.

Upon obtaining the aforementioned effect, the need for introduction of a new model or replacement by a new version in the existing digital copying machine or file management module can be basically obviated, and no extra load on the user is generated.

On the other hand, since the apparatus and method according to the present invention use the international standard protocol and encryption processing algorithm, they are free from limitations, i.e., dependence on the specifications of a specific single sign-on system. Hence, the developers of an apparatus and applications can develop products based on flexible product specifications.

Since user authentication information unique to each cabinet is encrypted using initial authentication information that only the user can know, and is held in the directory server, the security of that information can be maintained on the network and even for the administrator who has authority to access data of every users so as to manage the directory server.

As many apparently widely different embodiments of the present invention can be made without departing from the spirit and scope thereof, it is to be understood that the invention is not limited to the specific embodiments thereof except as defined in the claims.

What is claimed is:

1. An information management apparatus comprising:
data management means for controlling accesses to data which are stored in respective storage areas using authentication information;
storage area designation means for designating one of the storage areas;
authentication information acquisition means for recognizing the storage area designated by said storage area designation means, and acquiring encrypted authentication information required to access control to the designated storage area from authentication information management means; and
decryption means for decrypting the acquired encrypted authentication information,
wherein said data management means authenticates access to data in the designated storage area on the basis of the decrypted authentication information.

2. The apparatus according to claim 1, further comprising:
interface means for inputting initial authentication information used to initially authenticate a user; and
initial authentication information holding means for holding the input initial authentication information, and
wherein the initial authentication information is used in initial authentication required to access the designated storage area, and
the initial authentication information is held by said initial authentication information holding means until access to the storage area ends.

3. The apparatus according to claim 1, further comprising:
generating means for generating encrypted authentication information for the storage area on the basis of the initial authentication information held by said initial authentication information holding means,
wherein the generated encrypted authentication information is stored in the authentication information management means.

4. The apparatus according to claim 3, wherein said decryption means decrypts the encrypted authentication information on the basis of the initial authentication information held by said initial authentication information holding means.

5. The apparatus according to claim 1, wherein said authentication information acquisition means acquires the encrypted authentication information managed in the authentication information management means, on the basis of information which specifies the storage area designated by said storage area designation means, and the initial authentication information held by said initial authentication information holding means.

6. The apparatus according to claim 1, wherein said authentication information acquisition means uses a directory control protocol used to search the authentication information management means to acquire the encrypted authentication information.

7. An information management method comprising:
the storage area designation step of designating one of storage areas which undergo storage management for each storage area using individual authentication information;
the acquisition step of acquiring profile information corresponding to the designated storage area;
the specifying step of specifying authentication information management means that holds encrypted authentication information corresponding to the designated storage area on the basis of the acquired profile information;
the initial authentication checking step of binding to the specified authentication information management means; and
the storage area use step of decrypting encrypted authentication information managed in the specified authentication information management means, and authenticating access to data stored in the storage area designated in the storage area designation step on the basis of the decrypted authentication information.

8. An information management method comprising:
the data management step of controlling accesses to data which are stored in respective storage areas using authentication information;
the storage area designation step of designating one of the storage areas;
the authentication information acquisition step of recognizing the storage area designated by a process in the storage area designation step, and acquiring encrypted authentication information required to access control to the designated storage area from authentication information management means; and
the decryption step of decrypting the acquired encrypted authentication information,
wherein the data management step includes the step of authenticating access to data in the designated storage area on the basis of the decrypted authentication information.

9. The method according to claim 8, further comprising:
the interface step of inputting initial authentication information used to initially authenticate a user; and
the initial authentication information holding step of holding the input initial authentication information in storage means, and
wherein the initial authentication information is used in initial authentication required to access the designated storage area, and
the initial authentication information step includes the step of holding the initial authentication information in the storage means as effective authentication data until access to the storage area ends.

10. The method according to claim 8, further comprising, the generating step of generating encrypted authentication information for the storage area on the basis of the initial authentication information held in the storage means by a process of the initial authentication information holding step,
wherein the generated encrypted authentication information is stored in the authentication information management means.

11. The method according to claim 8, wherein the decryption step includes the step of decrypting the encrypted authentication information on the basis of the initial authentication information held by the storage means by a process in the initial authentication information holding step.

12. The method according to claim 8, wherein the authentication information acquisition step includes the step of acquiring the encrypted authentication information managed in the authentication information management means, on the basis of information which specifies the storage area designated by the process in the storage area designation step, and the initial authentication information held by the storage means by the process of the initial authentication information holding step.

13. An information management program for making computer function as an information management apparatus, program modules that said program makes the computer execute, comprising:
a data management module for controlling accesses to data which are stored in respective storage areas using authentication information;
a storage area designation module for designating one of the storage areas;
an authentication information acquisition module for recognizing the storage area designated by a process of said storage area designation module, and acquiring encrypted authentication information required to access control to the designated storage area from authentication information management means; and
a decryption module for decrypting the acquired encrypted authentication information,
wherein said data management module authenticates access to data in the designated storage area on the basis of the decrypted authentication information.

14. An image processing apparatus comprising:
data management means for controlling accesses to data which are stored in respective storage areas using authentication information;
storage area designation means for designating one of the storage areas;
authentication information acquisition means for recognizing the storage area designated by said storage area designation means, and acquiring encrypted authentication information required to access control to the designated storage area from authentication information management means;
decryption means for decrypting the acquired encrypted authentication information; and
image processing means for executing an image process on the basis of data stored in the designated storage,
wherein said data management means authenticates access to data in the designated storage area on the basis of the decrypted authentication information.

15. An information management apparatus for storing and managing data for respective storage areas, comprising:
management means for controlling accesses to data stored in respective storage areas using authentication information corresponding to each storage area;
storage area designation means for designating one of the storage areas; and
authentication information acquisition means for acquiring authentication information on the basis of information indicating the storage area designated by said storage area designation means,
wherein said management means makes authentication on the basis of the authentication information acquired by said authentication information acquisition means, and controls access to data stored in the storage area designated by said storage area designation means.

16. The apparatus according to claim 15, further comprising user designation means for designating a user, and
wherein said authentication information acquisition means acquires the authentication information, on the basis of the information indicating the storage area designated by said storage area designation means, and information indicating the user designated by said user designation means.

17. The apparatus according to claim 15, wherein said authentication information acquisition means transmits the information indicating the storage area designated by said storage area designation means to an external apparatus, and receives the authentication information retrieved by the external apparatus.

18. The apparatus according to claim 17, further comprising server specifying means for specifying an authentication server which corresponds to the storage area designated by said storage area designation means, and manages authentication information, and
wherein said authentication information acquisition means transmits the information indicating the storage area designated by said storage area designation means to the authentication server specified by said server specifying means, and receives the authentication means.

19. An information management method for storing and managing data for respective storage areas, comprising:
the storage area designation step of making a user designate one of the storage areas;
the authentication information acquisition step of acquiring authentication information on the basis of information indicating the storage area designated by the user in a process of the storage area designation step; and
the access control step of making authentication on the basis of the authentication information acquired by a process of the authentication information acquisition step, and controlling access to data stored in the storage area designated by the process of the storage area designation step.

20. An information management program for storing and managing data for respective storage areas, program modules that said program makes a computer execute, comprising:
a storage area designation module for making a user designate one of the storage areas;
an authentication information acquisition module for acquiring authentication information on the basis of information indicating the storage area designated by the user in a process of said storage area designation module; and
an access control module for making authentication on the basis of the authentication information acquired by a process of said authentication information acquisition module, and controlling access to data stored in the storage area designated by the process of said storage area designation module.
